(19) United States
(12) Patent Application Publication
(10) Pub. No.: US 2011/0161963 A1
(43) Pub. Date: Jun. 30, 2011

(54) METHODS, APPARATUSES, AND COMPUTER PROGRAM PRODUCTS FOR GENERATING A CYCLOSTATIONARY EXTENSION FOR SCHEDULING OF PERIODIC SOFTWARE TASKS

(75) Inventors: David Guevorkian, Tampere (FI); Yu-Huan Xu, Den Haag (NL); Johannes Westmeijer, Dorsten (DE)

(73) Assignee: Nokia Corporation

(21) Appl. No.: 12/651,126

(22) Filed: Dec. 31, 2009

(51) Int. Cl. G06F 9/46

(52) U.S. Cl. 718/102

(57) ABSTRACT

An apparatus for generating a cyclostationary extension for scheduling periodic software tasks may include a processor and a memory storing executable computer program code that causes the apparatus to at least perform operations including determining a time period including time periods associated with one or more radios. Each of the radios may include algorithms that are executable during respective time intervals of the time period. The computer program code may cause the apparatus to cyclically repeating each of the algorithms a number of times for the duration of the time period. In this regard, the algorithms may be executable a plurality of times during the time period. The computer program code may cause the apparatus to determine whether the algorithms are assignable to processors for execution during the respective time intervals based at least in part on a value. Corresponding computer program products and methods are also provided.

### TECHNOLOGICAL FIELD

Embodiments of the present invention relate generally to scheduling and assigning of tasks to processing elements of communication devices and, more particularly, relate to a method, apparatus and computer program product for generating a cyclostationary extension for scheduling one or more periodic software tasks.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. Due to the now ubiquitous nature of electronic communication devices, people of all ages and education levels are utilizing electronic devices to communicate with other individuals or contacts, receive services and/or share information, media and other content. One area in which there is a demand to increase ease of information transfer relates to utilizing Software Defined Radios (SDRs) in communication devices (e.g., mobile phones). By utilizing Software Defined Radios, components that may have been traditionally implemented in hardware may be implemented by software via digital baseband signals.

For instance, in Software Defined Radio, digital baseband signal processing is typically divided into software tasks which are scheduled by a scheduler and carried out by underlying processing elements, for example one or more processors and/or hardware accelerators. Due to limited processing capacity, power consumption and resources in a mobile device, an efficient schedule to perform the tasks is of importance for the overall system performance and hence Quality of Service (QoS) for the user of the mobile device.

In contrast to the traditional application-specific integrated circuit (ASIC) approach in which each radio baseband signal typically has its own dedicated signal processing hardware, the SDR approach is based on radio-independent signal processing resources such as for example a vector processor or a digital signal processor (DSP) which may be shared by a subset or all of the currently running radios on a communication device (e.g., mobile device). All signal processing tasks (e.g., channel estimation) of a communication device typically need to be assigned to one of the processing elements within the constraints given by their required processing time, dependencies to other tasks and absolute deadline set by corresponding radio standards.

There are drawbacks of current SDR approaches. For instance, a limiting factor in providing a search for an optional schedule may relate to the processing time of a scheduling algorithm utilized by the scheduler. In other words, the processing time associated with providing an exhaustive search for the most optimal schedule may be unacceptable in an operation environment utilizing radio baseband signals with clear real-time requirements. Such an exhaustive search may increase processing capacity and unduly utilize bandwidth resulting in an inefficient use of resources of the communication device.

Additionally, in online dynamic scheduling approaches, the scheduling for signal processing tasks are typically done when a task is activated during run-time. It should be pointed out that algorithms associated with SDRs may be periodic in nature. However, when a task is activated during run-time, the scheduler is typically not aware of the periodicity of the radio baseband signals associated with the task since it is only aware of the tasks currently being activated. In this regard, the scheduler may be unable to make predictions regarding the task(s) that need be implemented later. This will typically result in a situation where although the scheduler may specify that an algorithm is scheduled to be implemented during a time interval, it may not be possible to do so because of the constraints of a corresponding processor (for example, the computer program consisting of the instructions for the processor may not be loaded to the processor beforehand or in time for the processor to execute the computer program), or a number of other reasons.

As such, instructions may need to be loaded into a local memory associated with the processing elements on-the-fly or in other words at the same time that is known that a software task (or corresponding program) needs to be implemented. This is because in dynamic scheduling approaches, the programs may not be loaded to a processor's local memory before the execution needs to be started since the scheduler may not be aware of the upcoming tasks. However, providing on-the-fly instructions to the processing elements may jeopardize the tight timing constraints of the baseband signals in some instances.

In static scheduling approaches, the scheduler may be predefined with instructions regarding the manner in which to implement algorithms. For example, a scheduler may be predefined to implement a first algorithm during one time interval and then implement another algorithm during another time interval, etc. When static scheduling is utilized, the scheduler is typically predefined with the instructions during the design of the corresponding communication device. In other static scheduling approaches, for each radio baseband signal of an algorithm, one or more time slots on the processing elements may be reserved in advance for each signal processing task during the design (e.g., fabrication or manufacture) of the communication device. As such, the reserved time slots in which to implement algorithms may not typically be changed to account for dynamic run-time situations associated with different combinations of radios running in parallel, which may lead to sub-optimal schedules and over-dimensioning of resources (e.g., using more processors than are necessary).

In view of the foregoing drawbacks, it may be beneficial to provide a mechanism of utilizing specific properties of radio baseband signal processing to achieve an optimal and efficient schedule for implementing baseband signal processing tasks.

### BRIEF SUMMARY

A method, apparatus and computer program product are therefore provided that may determine the ability to schedule one or more software tasks for one or more processing elements of an apparatus (e.g., mobile terminal 10) in a feasible and efficient manner. In this regard, the exemplary embodiments provide a mechanism to analyze and determine the ability to schedule cyclostationary software tasks that are periodic. The cyclostationary software tasks may correspond, for example, to baseband signal processing algorithms of multiple radios. In other words, the radio baseband task sets corresponding to one radio typically have a cyclostationary property. As referred to herein a radio may be a sequence of algorithms for transmitting digital data according to a radio standard.

Each of the radios may have a set of algorithms that may be implemented for achieving the corresponding software tasks (e.g., tasks associated with channel estimation, demodulation, etc.). The exemplary embodiments may determine whether it is possible to schedule or assign each of the radios to one or more processing elements (e.g., a processor(s)) of an apparatus (e.g., a mobile terminal). In this regard, the exemplary embodiments may generate a period (also referred to herein as combined period) that combines the periods of each of the radios. The combined period may be generated based at least in part on a least common multiple of each of the periods associated with the radios. In this regard, the algorithms of each of the radios may be cyclically extended or repeated during the duration of the combined period. As such, the algorithms may be executable a number of times during the duration of the combined period.

The exemplary embodiments may also determine whether algorithms of the radios may be scheduled or assigned to one or more processing elements of an apparatus by evaluating the required processing time of each of the algorithms of each of the radios as well as the available processing time of all of the processing elements. The required processing time and the available processing time may be determined in part on the basis of a least common multiple of the periods of multiple radios.

Additionally, the exemplary embodiments may determine the impact that a bus transfer time has on scheduling or assigning the algorithms for implementation by one or more processing elements of an apparatus (e.g., mobile terminal). In this regard, the value of the bus transfer time may be utilized to determine whether the algorithms may be assigned or scheduled for implementation with a limited amount or number of data transfers between processing elements. Moreover, the exemplary embodiments may utilize the bus transfer time to determine whether scheduling or assignments of the algorithms to one or more processing elements may be guaranteed. In this manner, the exemplary embodiments facilitate efficient utilization of processing capacity and power consumption in communication devices.

In one exemplary embodiment, a method for generating a cyclostationary extension for scheduling one or more periodic software tasks is provided. The method may include determining a time period including a plurality of time periods associated with a plurality of radios or one or more other types of periodic software tasks. Each of the radios or periodic software tasks may include one or more algorithms that are executable during respective time intervals of the time period. The method may also include cyclically repeating each of the algorithms a number of times for the duration of the time period such that each of the algorithms are executable a plurality of times, according to the number, during the time period, and determining whether each of the algorithms are assignable to one or more processors for execution during the respective time intervals based at least in part on a value.

In another exemplary embodiment, an apparatus for generating a cyclostationary extension for scheduling one or more periodic software tasks is provided. The apparatus may include at least one processor and at least one memory storing computer program code configured to, with the at least one processor, cause the apparatus to determine a time period including a plurality of time periods associated with a plurality of radios or one or more other types of periodic software tasks. Each of the radios or periodic software tasks may include one or more algorithms that are executable during respective time intervals of the time period. The memory and the computer program code are further configured to, with the processor, cause the apparatus to cyclically repeat each of the algorithms a number of times for the duration of the time period such that each of the algorithms are executable a plurality of times, according to the number, during the time period, and determine whether each of the algorithms are assignable to one or more processors for execution during the respective time intervals based at least in part on a value.

In another exemplary embodiment, a computer program product for generating a cyclostationary extension for scheduling one or more periodic software tasks is provided. The computer program product may include at least one computer-readable storage medium having computer-executable program code instructions stored therein. The computer-executable program code instructions may include program code instructions for determining a time period including a plurality of time periods associated with a plurality of radios or one or more other types of periodic software tasks. Each of the radios or periodic software tasks may include one or more algorithms that are executable during respective time intervals of the time period. The computer-executable program code instructions may also include program code instructions for cyclically repeating each of the algorithms a number of times for the duration of the time period such that each of the algorithms are executable a plurality of times, according to the number, during the time period, and determining whether each of the algorithms are assignable to one or more processors for execution during the respective time intervals based at least in part on a value.

Embodiments of the invention take advantage of the cyclostationary property of radio baseband software tasks (also referred to herein as software task sets) to achieve feasible and efficient schedules, in particular, schedules that utilize dynamic scheduling. In this manner, the exemplary embodiments facilitate efficient utilization of processing capacity and power consumption in communication devices. As such, mobile terminal users may enjoy improved mobile device functionality.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic block diagram of a system according to an exemplary embodiment of the invention;

FIG. 2 is a schematic block diagram of an apparatus for generating a cyclostationary extension for scheduling one or more periodic software tasks according to an exemplary embodiment of the invention;

FIG. 3 is diagram of execution time intervals of tasks according to an exemplary embodiment;

FIG. 4 is a diagram of a radio modeled as a set of algorithms according to an exemplary embodiment;

FIG. 5 is a diagram of the periodicity of radio algorithms; and

FIG. 6 is a flowchart according to an exemplary method for generating a cyclostationary extension for scheduling one or more periodic software tasks according to an exemplary embodiment of the invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

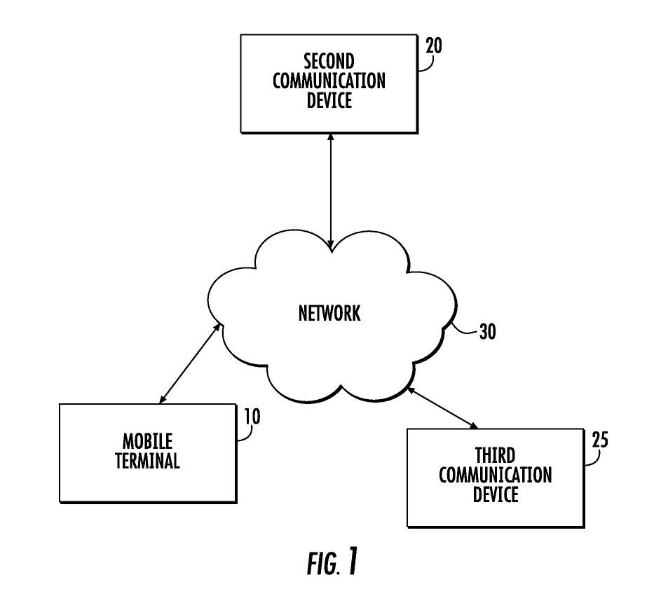

FIG. 1 illustrates a generic system diagram in which a device such as a mobile terminal 10 is shown in an exemplary communication environment. As shown in FIG. 1, an embodiment of a system in accordance with an example embodiment of the invention may include a first communication device (e.g., mobile terminal 10) and a second communication device 20 capable of communication with each other via a network 30. In some cases, embodiments of the present invention may further include one or more additional communication devices, one of which is depicted in FIG. 1 as a third communication device 25. In some embodiments, not all systems that employ embodiments of the present invention may comprise all the devices illustrated and/or described herein. While several embodiments of the mobile terminal 10 and/or second and third communication devices 20 and 25 may be illustrated and hereinafter described for purposes of example, other types of terminals, such as portable digital assistants (PDAs), pagers, mobile televisions, mobile telephones, gaming devices, laptop computers, cameras, video recorders, audio/video players, radios, global positioning system (GPS) devices, Bluetooth headsets, Universal Serial Bus (USB) devices or any combination of the aforementioned, and other types of voice and text communications systems, can readily employ embodiments of the present invention. Furthermore, devices that are not mobile, such as servers and personal computers may also readily employ embodiments of the present invention.

The network 30 may include a collection of various different nodes (of which the second and third communication devices 20 and 25 may be examples), devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of First-Generation (1G), Second-Generation (2G), 2.5G, Third-Generation (3G), 3.5G, 3.9G, Fourth-Generation (4G) mobile communication protocols, Long Term Evolution (LTE), and/or the like. In some embodiments, the network 30 may be a point-to-point (P2P) network.

One or more communication terminals such as the mobile terminal 10 and the second and third communication devices 20 and 25 may be in communication with each other via the network 30 and each may include an antenna or antennas for transmitting signals to and for receiving signals from a base site, which could be, for example a base station that is a part of one or more cellular or mobile networks or an access point that may be coupled to a data network, such as a Local Area Network (LAN), a Metropolitan Area Network (MAN), and/or a Wide Area Network (WAN), such as the Internet. In turn, other devices such as processing elements (e.g., personal computers, server computers or the like) may be coupled to the mobile terminal 10 and the second and third communication devices 20 and 25 via the network 30. By directly or indirectly connecting the mobile terminal 10 and the second and third communication devices 20 and 25 (and/or other devices) to the network 30, the mobile terminal 10 and the second and third communication devices 20 and 25 may be enabled to communicate with the other devices or each other, for example, according to numerous communication protocols including Hypertext Transfer Protocol (HTTP) and/or the like, to thereby carry out various communication or other functions of the mobile terminal 10 and the second and third communication devices 20 and 25, respectively.

Furthermore, although not shown in FIG. 1, the mobile terminal 10 and the second and third communication devices 20 and 25 may communicate in accordance with, for example, radio frequency (RF), near field communication (NFC), Bluetooth (BT), Infrared (IR) or any of a number of different wireline or wireless communication techniques, including Local Area Network (LAN), Wireless LAN (WLAN), Worldwide Interoperability for Microwave Access (WiMAX), Wireless Fidelity (WiFi), Ultra-Wide Band (UWB), Wibree techniques and/or the like. As such, the mobile terminal 10 and the second and third communication devices 20 and 25 may be enabled to communicate with the network 30 and each other by any of numerous different access mechanisms. For example, mobile access mechanisms such as Wideband Code Division Multiple Access (W-CDMA), CDMA2000, Global System for Mobile communications (GSM), General Packet Radio Service (GPRS) and/or the like may be supported as well as wireless access mechanisms such as WLAN, WiMAX, and/or the like and fixed access mechanisms such as Digital Subscriber Line (DSL), cable modems, Ethernet and/or the like.

In example embodiments, the first communication device (e.g., the mobile terminal 10) may be a mobile communication device such as, for example, a wireless telephone or other devices such as a personal digital assistant (PDA), mobile computing device, camera, video recorder, audio/video player, positioning device, game device, television device, radio device, or various other like devices or combinations thereof. The second communication device 20 and the third communication device 25 may be mobile or fixed communication devices. However, in one example, the second communication device 20 and the third communication device 25 may be servers, remote computers or terminals such as personal computers (PCs) or laptop computers.

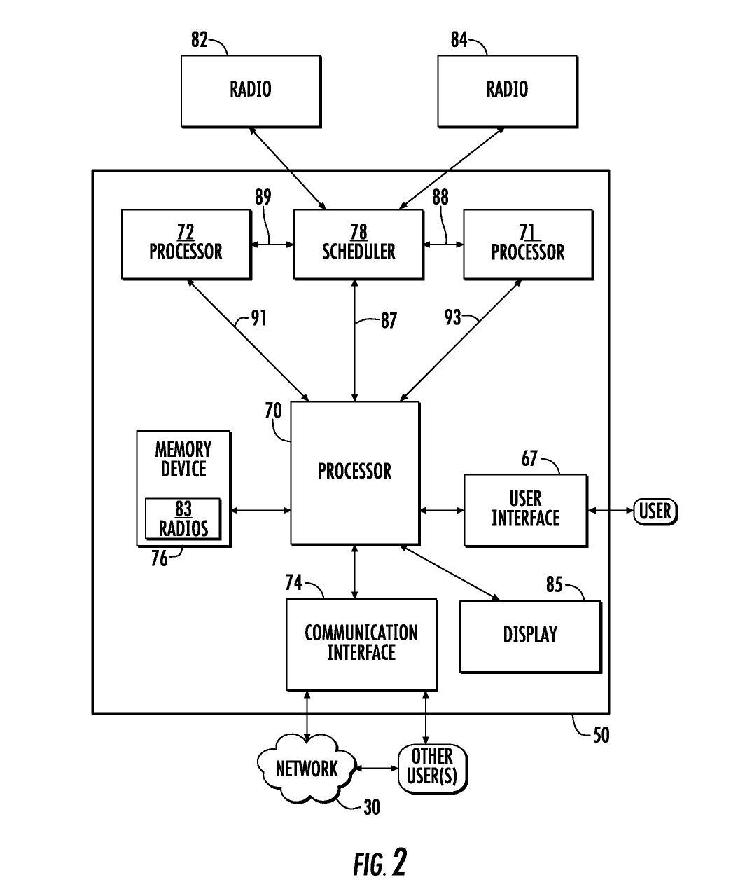

In an exemplary embodiment, the network 30 may be an ad hoc or distributed network arranged to be a smart space. Thus, devices may enter and/or leave the network 30 and the devices of the network 30 may be capable of adjusting operations based on the entrance and/or exit of other devices to account for the addition or subtraction of respective devices or nodes and their corresponding capabilities. In an exemplary embodiment, one or more of the devices in communication with the network 30 may employ a scheduler (e.g., scheduler 78 of FIG. 2). The scheduler may assign one or more radios, which correspond to periodic software tasks, to one or more processors of a communication device (e.g., mobile terminal 10) for implementation during time intervals.

The radios (e.g., radios 83 of FIG. 2) may include one or more algorithms for performing functions associated with the software tasks during time intervals. In this regard, the scheduler may assign or schedule a processor to implement (also referred to herein as execute) one or more algorithms of a radio and may assign a time in which the processor is to implement the algorithm(s). Additionally, the scheduler may determine that the algorithms should be implemented during a given time interval or period. In this regard, the scheduler may determine whether the algorithms may be implemented by one or more deadlines in order to achieve a quality of service (e.g., QoS). The scheduler may also determine the priority of implementing the algorithms and whether one or more algorithms share a dependency. If the scheduler 78 determines that algorithms share a dependency, one algorithm may not be started (or implemented) until a previous algorithm is implemented. In contrast, when scheduler 78 determines that there is no interdependency, one algorithm may be implemented while another algorithm is being implemented.

It should be pointed out that the algorithms may include software code or instructions for performing a function upon execution by a processor. Additionally, it should be pointed out that the algorithms may correspond to software tasks for performing synchronization, Fast Fourier Transforms (FFTs), channel estimation, demodulation, sampling rate correction (e.g., finite impulse response (FIR) filtering) and functions associated with voice data, wireless local area network (WLAN) data, near field communication (NFC) data, Bluetooth data, Internet Protocol (IP) data, global positioning system (GPS) data or any other suitable data or functions associated with tasks that correspond to communication protocols (e.g., wireless communication protocols). However, it should be pointed out that the software tasks are not limited to tasks associated with communication protocols.

In an exemplary embodiment, the mobile terminal 10 and the second and third communication devices 20 and 25 may be configured to include the scheduler. However, in other alternative embodiments the mobile terminal 10 may include the scheduler and the second and third communication devices 20 and 25 may be network entities such as servers or the like that are configured to communicate with the mobile terminal 10.

In an exemplary embodiment, the mobile terminal as well as the second and third communication devices 20 and 25 may employ an apparatus (e.g., apparatus of FIG. 2) capable of employing embodiments of the invention.

FIG. 2 illustrates a schematic block diagram of an apparatus for generating a cyclostationary extension for scheduling one or more periodic software tasks according to an exemplary embodiment of the invention. An exemplary embodiment of the invention will now be described with reference to FIG. 2, in which certain elements of an apparatus 50 are displayed. The apparatus 50 of FIG. 2 may be employed, for example, on the mobile terminal 10 (and/or the second communication device 20 or the third communication device 25). Alternatively, the apparatus 50 may be embodied on a network device of the network 30. However, the apparatus 50 may alternatively be embodied at a variety of other devices, both mobile and fixed (such as, for example, any of the devices listed above). In some cases, embodiments may be employed on a combination of devices. Accordingly, some embodiments of the present invention may be embodied wholly at a single device (e.g., the mobile terminal 10), by a plurality of devices in a distributed fashion (e.g., on one or a plurality of devices in a P2P network) or by devices in a client/server relationship. Furthermore, it should be noted that the devices or elements described below may not be mandatory and thus some may be omitted in certain embodiments.

Referring now to FIG. 2, an apparatus for generating a cyclostationary extension for scheduling one or more periodic software tasks is provided. The apparatus 50 may include or otherwise be in communication with a processor 70, a processor 71, a processor 72, a user interface 67 a communication interface 74, a memory device 76, a display 85, and a scheduler 78. While three processors 70, 71 and 72 are shown in FIG. 2, it should be pointed out that any suitable number of processors may be included or embodied in the apparatus 50. Additionally, although the processors are shown as separate devices the processors may be embodied in a single device without departing from the spirit and scope of the invention.

The memory device 76 may include, for example, volatile and/or non-volatile memory. The memory device 76 may be configured to store information, data, applications, one or more radios (e.g., radios 83) instructions or the like for enabling the apparatus to carry out various functions in accordance with exemplary embodiments of the invention. In an exemplary embodiment, the software code for performing the functions associated with the algorithms of radios may also be stored in memories (not shown) of the processors 70, 71 and 72. While the software code associated with the radios may be stored in memory device 76, it should be pointed out that data associated with the radios (e.g., radios 82 and 84) may be received by apparatus 50 from another communication device (e.g., second communication device 20 or third communication device 25) and may be stored by the scheduler 78 in a memory (e.g., memory device 76) of the apparatus 50 or local memories of processors 70, 71 and 72. It should be pointed out that the memory device 76 could be configured to buffer input data for processing by the processors 70, 71 and/or 72. Additionally or alternatively, the memory device 76 could be configured to store instructions for execution by the processors 70, 71 and/or 72. As yet another alternative, the memory device 76 may be one of a plurality of databases that store information and/or media content. The radios may include one or more algorithms (e.g., a set of algorithms) for performing functions associated with software tasks during time intervals, as described above. The algorithms may include software code or instructions for performing one or more functions upon execution by any of the processors 70, 71 or 72.

The processors 70, 71 and 72 may be embodied in a number of different ways. For example, the processors 70, 71 and 72 may be embodied as various processing means such as a processing element, a coprocessor, a controller or various other processing devices including integrated circuits such as, for example, an ASIC (application specific integrated circuit), an FPGA (field programmable gate array), a hardware accelerator, or the like. In an exemplary embodiment, the processors 70, 71 and 72 may be configured to execute instructions as well as algorithms associated with radios (e.g., radios 83) stored in the memory device 76 or otherwise accessible to the processors 70, 71 and 72. As such, whether configured by hardware or software methods, or by a combination thereof, the processors 70, 71 and 72 may represent an entity (e.g., physically embodied in circuitry) capable of performing operations according to embodiments of the present invention while configured accordingly. Thus, for example, when the processors 70, 71 and 72 are embodied as an ASIC, FPGA or the like, the processors 70, 71 and 72 may be specifically configured hardware for conducting the operations described herein. Alternatively, as another example, when the processors 70, 71 and 72 are embodied as an executor of software instructions, the instructions may specifically configure the processors 70, 71 and 72, which may otherwise be general purpose processing elements or other functionally configurable circuitry if not for the specific configuration provided by the instructions, to perform the algorithms and operations described herein. However, in some cases, the processors 70, 71 and 72 may be processors of a specific device (e.g., a mobile terminal) adapted for employing embodiments of the invention by further configuration of the processors 70, 71 and 72 by instructions for performing the algorithms and operations described herein. The processors 70, 71 and 72 may receive instructions or commands from scheduler 78. These instructions or commands received from the scheduler 78 may include data assigning a respective processor (e.g., processor 70) to implement or execute one or more algorithms of the radios (e.g., radio 82) during particular time intervals. Additionally, the instructions may include times at which the algorithms should be implemented by respective processors (e.g., processors 70, 71 and 72). The instructions or commands may be received by the processors 70, 71 or 72 from the scheduler 78 via one or more buses 87, 88 and 89. In an alternative exemplary embodiment, the buses 87, 88 and 89 may be a single bus or may be parts of the same bus.

In an exemplary embodiment, the processor 70 may be configured to operate a connectivity program, such as a conventional Web browser. The connectivity program may then enable the apparatus 50 to transmit and receive Web content, such as location-based content, according to a Wireless Application Protocol (WAP), for example. The processor 70 may also be in communication with a display 85 and may instruct the display to illustrate any suitable information, data, content (e.g., media content) or the like.

Meanwhile, the communication interface 74 may be any means such as a device or circuitry embodied in either hardware, software, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (e.g., network 30). In fixed environments, the communication interface 74 may alternatively or also support wired communication. The communication interface 74 may receive and/or transmit data via one or more communication channels. Additionally, in some embodiments the communication interface 74 may include a communication modem and/or hardware/software for supporting communication via cable, digital subscriber line (DSL), universal serial bus (USB), Ethernet or other mechanisms.

The user interface 67 may be in communication with the processor 70 to receive an indication of a user input at the user interface 67 and/or to provide an audible, visual, mechanical or other output to the user. As such, the user interface 67 may include, for example, a keyboard, a mouse, pointing device (e.g., stylus, pen, etc.) a joystick, a display, a touch screen, a microphone, a speaker, or other input/output mechanisms. In an exemplary embodiment in which the apparatus is embodied as a server or some other network devices, the user interface 67 may be limited, remotely located, or eliminated.

It should be pointed out that the processor 70 may comprise user interface circuitry configured to control at least some functions of one or more elements of the user interface. The processor and/or user interface circuitry of the processor may be configured to control one or more functions of one or more elements of the user interface through computer program instructions (e.g., software and/or firmware) stored on a memory accessible to the processor (e.g., volatile memory, non-volatile memory, and/or the like).

In an exemplary embodiment, the processor 70 may be embodied as, include or otherwise control a scheduler 78. The scheduler 78 may be any means such as a device or circuitry operating in accordance with software or otherwise embodied in hardware or a combination of hardware and software (e.g., processor 70 or another processor (not shown) operating under software control, the processor 70 embodied as an ASIC or FPGA specifically configured to perform the operations described herein, or a combination thereof) thereby configuring the device or circuitry to perform the corresponding functions of the scheduler 78 as described below. Thus, in examples in which software is employed, a device or circuitry (e.g., the processor 70 in one example) executing the software forms the structure associated with such means. In this regard, for example, the scheduler 78 may be configured to provide, among other things, for the assigning of one or more processors (e.g., processor 70, 71, 72) to implement or execute one or more algorithms of one or more corresponding radios. In this regard, the scheduler 78 may assign a particular processor (e.g., processor 71) to implement or execute algorithms of a radio(s) and may specify the time at which to begin the implementation.

Additionally, the scheduler 78 may provide the processors 70, 71 and 72 with data specifying the time intervals in which particular algorithms are to be implemented as well as any other suitable data or instructions.

In an exemplary embodiment, the scheduler 78 may determine whether it is or is not possible for a particular set of processors to implement all algorithms of all currently designated to run radios in a given time interval. This determination may be made by the scheduler 78 in part by analyzing the available processing time of all of the processors (also referred to herein as Tₐₚ) and the required processing time of all the possessors (also referred to herein as Tₚ) for implementing assigned algorithms for example, as described more fully below. The scheduler 78 may communicate with each of the processors 70, 71 and 72 via buses 87, 88 and 89, respectively. Additionally, the processors 70, 71 and 72 may communicate with each other via buses 91 and 93. In an exemplary embodiment, the buses 87, 88, 89, 91 and 93 may be the same bus. The buses 87, 88 and 89 are capable of transferring data between the scheduler and the processors 70, 71 and 72 and the buses 91 and 93 are capable of transferring data between the processors 70, 71 and 72.

It should be pointed out that the scheduler 78 may determine the schedulability of cyclostationary software tasks associated with the algorithms of the radios of the exemplary embodiments. In this manner, the scheduler 78 may achieve a feasible schedule in an efficient manner which may efficiently utilize the processing capacity of an apparatus (e.g., apparatus 50 (e.g., mobile terminal 10)). The algorithms of the radios may be cyclostationary in that they are periodic in nature during a time interval of implementation. For example, consider a radio that is associated with processing Internet Protocol (IP) data from a WLAN. Once the IP data (e.g., data from a webpage) is received by the apparatus 50, the scheduler 78 may utilize a corresponding radio (e.g., radio 82) that was received from a device such a network entity (e.g., third communication device 25) for example. Additionally, suppose that the radio includes two algorithms. In this regard, the scheduler 78 may instruct or assign a processor (e.g., processor 70) to implement the algorithms of the radio and in this regard the processor (e.g., processor 70) may implement a first algorithm (also referred to herein as algorithm D) during a corresponding time interval (e.g., before a deadline) and the processor may implement another algorithm (e.g., also referred to herein as algorithm E) during a time interval. The processor (e.g., processor 70) may repeat this process of implementing algorithm D and algorithm E periodically or repetitively for the duration of the receipt of the IP data (e.g., radio data) and in this regard the WLAN radio may be periodic or cyclostationary. In the example above, it should be pointed out that if the processor is unable to implement either of algorithms D or E within the corresponding deadline at each period, the IP data may at least partially not be processed in a reasonable time which may be undesirable for the user of the apparatus 50.

To achieve a feasible schedule in an efficient manner, the scheduler 78 may consider the set of time intervals corresponding to the algorithms of the radios to be as follows:

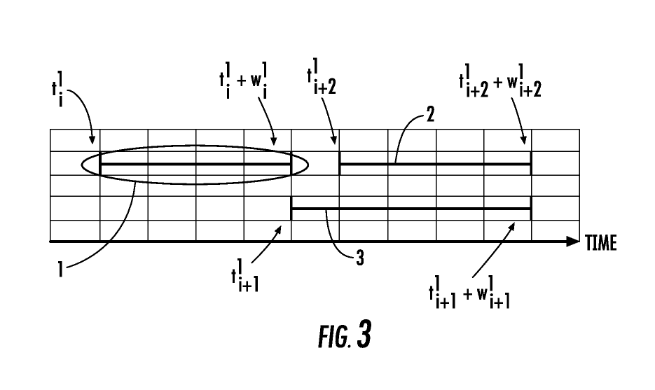

S¹={A₀¹,A₁¹, . . . Aₘ_{₁}¹}, with Aᵢ¹=[tᵢ¹,tᵢ¹+wᵢ¹] (1)
tᵢ¹ε [symbol] : starting time of i^{th} algorithm part of radio 1 relative to t₀¹
wᵢ¹ε [symbol] : processing time of i^{th} algorithm
m₁ε [symbol]
   in which equation (1) represents the timing information of m₁ algorithms in a single radio S¹ (e.g., radio 82). In equation (1) S¹ relates to a collection of time intervals (A₀¹, A₁¹, . . . Aₘ₁¹) for each of the algorithms of radio 1. In this regard, a radio may be a chain of algorithms. Additionally, in equation (1) tᵢ¹ corresponds to a starting time of an i^{th} algorithm (e.g., algorithm 1) of radio 1 relative to an initial time t₀¹ and, wᵢ¹ corresponds to the implementation time or processing time of an i^{th} algorithm of a single radio (e.g., radio 1 (e.g., radio 82). In this regard, tᵢ¹+wᵢ¹ corresponds to the time interval for implementing an i^{th} algorithm (e.g., algorithm 1). The starting time tᵢ¹ is defined such that it is the earliest possible time to start. In this regard, equation (1) may allow dependency on preceding algorithms with respect to time tᵢ¹, since the preceding algorithms may need to be implemented prior the implementation of an i^{th} algorithm (e.g., algorithm 1) for example. In this regard, the set is ordered in the sense that tᵢ¹≦tᵢ₊₁¹. Note that Aᵢ¹∩Aⱼ¹ does not have to be empty for any i,jε0 . . . m₁ [symbol] i≠j and as such equation (1) does allow algorithm concurrency. As an example of algorithms being implemented concurrently see algorithms 2 and 3 of FIG. 3.

Referring now to FIG. 3, an exemplary embodiment of execution time intervals for tasks according to equation (1) is provided. As shown in FIG. 3, none of the algorithms are implemented prior to tᵢ¹. In FIG. 3, algorithm 1 of radio 1 has a time interval or period of implementation, for example by a processor, of tᵢ¹+wᵢ¹. Additionally, algorithm 2 of radio 1 has a time interval or period of implementation of tᵢ₊₂¹+wᵢ₊₂¹ and algorithm 3 of radio 1 has a time interval or period of implementation of tᵢ₊₁¹+wᵢ₊₁¹. As shown in FIG. 3, implementation of algorithm 3 by a processor may be started before the implementation of algorithm 2 is complete. In this regard, algorithms 2 and 3 are independent of each other but are only dependent on the preceding algorithms.

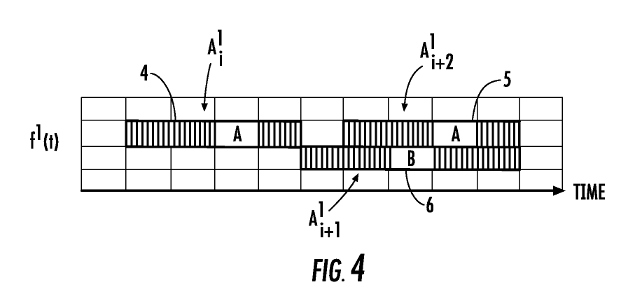

According to the exemplary embodiments, a radio may be modeled as a series of pulses by the scheduler 78 for example. In this regard, a radio may be modeled as a series of pulses for m₁ algorithms based on equation (2) below

$${f}^{1} ( t ) = {\sum }_{k = 0}^{{m}_{1}} {1}_{{A}_{k}^{1}} ( t ) , with {1}_{{A}_{k}^{1}} ( t ) = \{ \begin{matrix}1 & t ∈ {A}_{k}^{1} \\ 0 & otherwise ,\end{matrix} \qquad ( 2 )$$

where 1_{A}(t) denotes that the algorithm is being executed during time interval A and f¹(t) denotes function over time. In this regard FIG. 4, shows that the scheduler 78 may assign algorithm 4 corresponding to radio 1 to be executed or implemented by a processor during time interval Aᵢ¹. The scheduler 78 may also assign algorithm 5 corresponding to radio 1 to be implemented by a processor during a time interval Aᵢ₊₂¹ and the scheduler 78 may assign algorithm 6 of radio 1 to be executed or implemented by a processor during time interval Aᵢ₊₁¹. In this regard, the radio of FIG. 4 may be modeled (from the scheduling point of view) as a function of time given by:

$${f}^{1} ( t ) = \{ \begin{matrix}1 & if t ∈ {A}_{i}^{1} or ( t ∈ {A}_{i + 1}^{1} \& t ∉ {A}_{i + 2}^{1} ) , \\ 2 & if t ∈ {A}_{i + 2}^{1} , \\ 0 & otherwise ..\end{matrix}$$

When f¹(t) is cyclically or repetitively extended with period T¹, a periodic function is obtained according to equation (3):

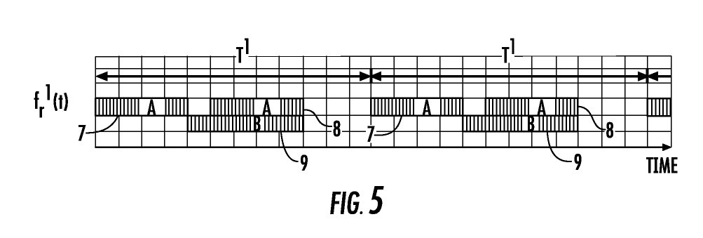

fᵣ¹(t)=f¹(t+a·T¹), aε [symbol] (3),
r=repetitive
   where, t corresponds to time, fᵣ¹(t) is a periodic function over time of f¹(t) as depicted in FIG. 5 and a corresponds to an integer. In this regard, the scheduler 78 may determine that fᵣ¹(t) is periodic or cyclic or repetitive, which means that the scheduler 78 may determine the cyclostationary nature or periodicity of algorithms for a radio(s) (e.g., radio 1) over time based on equation (3). The scheduler 78 may know the duration(s) of time intervals in which one full chain of algorithms of a radio(s) should be implemented, for example based on the requirements defined by a communication standard (e.g., a CDMA communication standard). In this regard, the scheduler 78 may utilize this information to determine a period of algorithms associated with the radio and may repeat the chain of algorithms for each period while a new portion of data (e.g., an orthogonal frequency-division multiplexing (OFDM) symbol) is being received, for example.

Referring now to FIG. 5, an exemplary embodiment of the periodicity of radio algorithms according to an exemplary embodiment is provided. In the embodiment of FIG. 5, T¹ may correspond to the period of one OFDM symbol (e.g., duration 20 ms), or any other natural sized data packet that may be processed by a processor (e.g., processor 71). By utilizing equation (3), the scheduler 78 may determine the periodic nature of algorithms 7, 8 and 9 and may repeat all the algorithms or computations associated with one period multiple times for each new data portion (e.g., a data packet (e.g., OFDM symbols)) received by the apparatus 50 (e.g., mobile terminal 10). In the exemplary embodiment of FIG. 5, the scheduler 78 may determine that algorithm 7 needs to be implemented first and then algorithm 8 and algorithm 9 may be implemented concurrently during receipt of a data packet having a period T¹. Once the first period T¹ is completed, the scheduler 78 may repeat all the computations of the period when another data packet is being received by the apparatus 50. In this regard, during the second period T¹, algorithms 7, 8 and 9 may be implemented again in the same manner as during the first period T¹ and this process may continue as long as data packets are being received by the apparatus 50.

It should be pointed out that in the exemplary embodiment of FIG. 5 the algorithms 7, 8 and 9 are being implemented within their assigned time intervals and met their respective deadlines since there is additional time in the period T¹ in which the algorithms are not being implemented. Although FIG. 5 does not show overlap in signal processing of algorithms between the periods T¹, an overlap between periods T¹ may exist. For instance, it should be pointed out that if the period T¹ was of a lesser duration than the time it takes to implement algorithms 8 and 9, the implementation of algorithms 8 and 9 may need to be completed during the second period T¹ when implementation of the algorithm 7 may have started for a second time during the second period T¹.

It should be pointed out that in the case of multiple, say n, radios designated to be concurrently implemented by a device, the scheduler may determine that the i^{th} radio, i=1, . . . , n nε [symbol] , may be defined as

$${f}^{i} ( t ) = {\sum }_{k = 0}^{{m}_{i}} {1}_{{A}_{k}^{i}} ( t ) ,$$

having period Tⁱ and time intervals Sⁱ={A₀ⁱ, A₁ⁱ, . . . Aₘ_{ᵢ}ⁱ}. Assuming Tⁱ being natural numbers in nanoseconds ns or μs, the periods Tⁱ of f¹(t), . . . , fⁿ(t) have their least common multiple defined as

$${T}_{lcm} = \frac{{T}^{1} \cdot {T}^{2} \cdot … \cdot {T}^{n}}{gcd ( {T}^{1} , {T}^{2} , … , {T}^{n} )} , \qquad ( 4 )$$

where gcd stands for the greatest common divisor of T¹, T², . . . , Tⁿ.

The least common multiple (T_{lcm}) in equation (4) may be a mechanism utilized by the scheduler 78 to combine the periods of multiple radios to generate one common period in which to implement the algorithms associated with the radios. As an example in which the scheduler 78 may determine the least common multiple, consider a situation in which radio 1 has a period of 2 μs and radio 2 has a period of 3 μs. In this example, the period T¹ (e.g., 2 μs) of radio 1 and the period T² (e.g., 3 μs) of radio 2 may correspond to the total of the time intervals for implementing corresponding algorithms of each of the radios. Since only two radios are being considered in this example Tⁿ equals T² which corresponds to 3 μs for radio 2 and T¹ equals 2 μs for radio 1. As such, the greatest common divisor of radios 1 and 2 is 1 since there is not any number that both 2 and 3 are commonly divisible by. (In contrast, if T¹⁼12 μs and T²=18 μs then gcd=6 for example). In this regard, 2 and 3 may be considered to be coprime or relatively prime since they have no common positive factor other than 1. As such, T_{lcm} equals (2 μs×3 μs)/1 which equals 6 μs. In this manner, the algorithms associated with radio 1 and the algorithms associated with radio 2 may be implemented during a period of 6 μs in this example.

Since the period of the radios 1 and 2 in the example above are now combined or merged in a period (also referred to herein as combined period) of 6 μs, the algorithms for radio 1 may be repeated or extended three times during the 6 μs period given that the algorithms of radio 1 may be implemented in 2 μs. Similarly, the algorithms of radio 2 may be repeated or extended 2 times during the 6 μs combined period since the algorithms of radio 2 may be implemented in 3 μs. In this regard, radio 1 is cyclically extended (also referred to herein as cyclostationarily extended) three times and radio 2 is cyclically extended two times. Since the algorithms of radio 1 and radio 2 may be implemented in the combined period, the algorithms of radio 1 and radio 2 may constitute a new “mixed” application.

In other words, the algorithms of radio 1 and radio 2 are mixed together in such a way that the cyclostationary nature of the individual radios is preserved to obtain a total application. Determining the cyclostationary nature of the total application associated with the algorithms of multiple radios may help the scheduler 78 to determine a schedule for implementing the algorithms.

The radio model may now be a union of mixed applications repeated or extended with respect to a period T_{lcm}, and by concatenating each set Sⁱ, i=1, . . . , n,

$$\frac{{T}_{lcm}}{{T}^{i}}$$

times, the scheduler 78 may obtain

$${S}_{r}^{i} = \{ {A}_{0}^{i} , {A}_{1}^{i} , … {A}_{( \frac{{T}_{lcm}}{{T}^{i}} - 1 ) {T}^{i} + {m}_{i}}^{i} \} ,$$

which may be interpreted as the cyclic extension of radio fⁱ(t). The time intervals for the mapping process may be obtained by merging and ordering the n sets Sᵣ¹ into

S=Sᵣ¹∪ . . . ∪Sᵣⁿ (5).

in which Sᵣⁱ denotes the union of a set of radios mapped over all time intervals associated with the algorithms of the set of radios.

The schedulability of the set of tasks by the scheduler 78 may be determined by dividing the required processing time Tₚ for all radios repeated a respective amount of times

$$\frac{{T}_{lcm}}{{T}^{i}}$$

by the available processing time Tₐₚ for all processors as follows,

$$η = \frac{{T}_{p}}{{T}_{ap}} = \frac{{\sum }_{i = 1}^{n} \frac{{T}_{lcm}}{{T}^{i}} {\sum }_{j = 0}^{{m}_{i}} {w}_{j}^{i}}{{T}_{lcm} \vert PE \vert} \qquad ( 6 )$$

where ∥ denotes cardinality or amount of elements of the set of processing elements (PE) or the total number of PEs, i corresponds to the number of a radio and j denotes the number of an algorithm within the radio i,

$${\sum }_{j = 0}^{m i} {w}_{j}^{i}$$

is equal to the processing time of all algorithms for radio i,

$${\sum }_{i = 1}^{n}$$

denotes the total processing time or implementation time for all algorithms of all radios that are being cyclo-stationary extended with respect to

$$\frac{{T}_{lcm}}{{T}^{i}}$$

meaning that each algorithm of the radio i is performed

$$\frac{{T}_{lcm}}{{T}^{i}}$$

times (where Tⁱ is the period of radio i) during time period of T_{lcm}. In this regard, the required processing time Tₚ corresponds to the total processing time of all algorithms of radio i, multiplied by

$$\frac{{T}_{lcm}}{{T}^{i}} .$$

It should also be noted that Tₐₚ is also calculated for the time period of T_{lcm} and as such a period associated with the least common multiple is multiplied by the total number of processing elements.

If η is larger than 1, the scheduler 78 may conclude that the combined radios cannot be mapped on the available hardware (e.g., processors 70, 71 and 72). In an exemplary embodiment when the scheduler 78 determines that η is larger than 1, the scheduler 78 may determine not to generate any schedule for the processing elements (e.g., processors 70, 71, 72). It should be pointed out that the scheduler 78 may determine that there is more processing time needed than there is power available among the processor elements (e.g., processors 70, 71 and 72) when the scheduler 78 determines that η is larger than 1. On the other hand, if η is less than 1, the scheduler 78 may conclude that the combined radios may be mapped on available hardware (e.g., processors 70, 71 and 72). In this regard, the scheduler 78 may assign one or more processors to implement algorithms of the combined radios, and the scheduler 78 may instruct the processors as to which time to begin the implementations for respective algorithms as well as the time intervals (e.g., deadlines) in which each algorithm is to be implemented.

It should also be pointed out that for a practical use by scheduler 78, equation (6) may be simplified as follows:

$$η = \frac{{T}_{p}}{{\overline{T}}_{ap}} = \frac{1}{\vert PE \vert} {\sum }_{i = 1}^{n} \frac{1}{{T}^{i}} {\sum }_{j = 0}^{{m}_{i}} {w}_{j}^{i}$$

Additionally, it should be pointed out that equation (6) may be useful for instances in which the processing elements are uniform or exactly the same. However, in all instances it may not necessarily be the case that the processing elements (e.g., processors 70, 71, 72) are exactly the same or of the same type of processors (for e.g., the processors may be a Philips™ EVP processor, a TI™ Fixed-Point DSP TMS320C64 processor, a Silicon Hive™ AVISPA CH-1 processor or any other suitable type of processor). When the processing elements are of different types, non-uniform mapping may be applied by the scheduler 78. When non-uniform mapping is applied, the scheduler 78 may split the algorithms into groups or clusters according to their place of execution by a particular processor (e.g., processor 70). In this regard, the scheduler 78 may determine the types of processors of apparatus 50 (e.g., mobile terminal 10). Suppose for example that the scheduler 78 determines that processor 70 is of one type (e.g., type 1) and processors 71 and 72 are processors of a second type (e.g., type 2). In this manner, the scheduler 78 may classify the algorithms and associate or assign the classified algorithms with types of processors. For instance, the scheduler 78 may classify a first group or cluster (also referred to herein as cluster I) of algorithms and may determine that the cluster I algorithms are associated (e.g., are assigned to be implemented) with a first type of processor (e.g., type 1 (e.g., processor 70)). Similarly, the scheduler 78 may classify a second group or cluster (also referred to herein as cluster II) of algorithms and may determine that the cluster II algorithms are associated (e.g., are assigned to be implemented) with a second type of processor (e.g., type 2 (e.g., processors 71 or 72)). The scheduler may determine a time that it would take a type(s) of processor(s) to implement the cluster(s) of algorithms when scheduler 78 associates the clusters with respective types of processors.

When dividing the algorithms into clusters I and II equation (6) becomes

$${η}^{′} = max \{ \frac{{T}_{p}^{′}}{{T}_{ap}^{′}} , \frac{{T}_{p}^{″}}{{T}_{ap}^{″}} \} , \\ with \\ {T}_{p}^{′} \text{:} required processing time of cluster I algorithms \\ {T}_{ap}^{′} \text{:} required processor time of cluster I algorithms \\ {T}_{p}^{″} \text{:} required processing time of cluster II algorithms \\ {T}_{ap}^{″} \text{:} available processor time for cluster II algorithms . \qquad ( 6 a )$$

where Tₚ′ and Tₐₚ′ may be determined using equation (6) above for all processors associated with type 1 and Tₚ″ and Tₐₚ″ may be determined using equation (6) above for all processors associated with type 2. It should be pointed out that to determine η′ the scheduler 78 may determine the values for both Tₚ′/Tₐₚ′ and Tₚ″/Tₐₚ″ and in this regard the scheduler 78 may take the maximum value of Tₚ′/Tₐₚ′ and Tₚ″/Tₐₚ″ as the value of η′. If η′ is larger than 1, the scheduler 78 may determine that the combined radios cannot be mapped on the available hardware (e.g., processors 70, 71 and 72), in a similar manner as described above with respect to η. On the other hand, if η′ is less than 1, the scheduler 78 may conclude that the combined radios may be mapped on available hardware (e.g. processors 71, 72 and 73), in a similar manner as described above with respect to η.

The characteristic of the 2-cluster case described above is: PE=PE^{I}∪PE^{II}, PE^{I}∩PE^{II}=Ø, PE^{I,II}≠Ø. It should be pointed out that this process may be extended when there are more than 2-clusters of algorithms. For instance, a third cluster of algorithms associated with a third type of processor, so on and so forth.

The scheduler 78 may also take into account data transfer via a bus (e.g., buses 87, 88, 89) extending Tₚ in equation (6) into

$${T}_{p + b} = {\sum }_{i = 1}^{n} \frac{{T}_{lcm}}{{T}^{i}} {\sum }_{j = 0}^{{m}_{i}} {( w + t\_bus )}_{j}^{i} . \qquad ( 6 )$$

where T_{p+b} denotes the required processing time and the time associated with data bus transfer and (w+t_bus)ⁱⱼ represents the execution of the i^{th} algorithm including the time associated with data bus transfer. In this regard, the scheduler 78 may determine T_{p+b} and account for the time that it may take the scheduler 78 to transfer data between one or more of the processors (e.g., processors 70, 71 and 72) via one or more buses (e.g., buses 87, 88, 89) or the time it takes the processors 70, 71 and 72 to transfer data between each other via one or more buses (e.g., buses 91 and 93. If the ratio

$$\frac{{T}_{p + b}}{{T}_{ap}}$$

is larger than 1, the scheduler 78 may determine that algorithms may only be mapped (or assigned) to processing elements with a limited amount or limited number of data transfers

$$( < {\sum }_{i = 1}^{n} \frac{{T}_{lcm}}{{T}_{u}} {m}_{i} )$$

between the scheduler 78 and different processing elements (e.g., processors 70, 71, 72). In this regard, a value of

$$\frac{{T}_{p + b}}{{T}_{ap}}$$

greater than 1 may signify to the scheduler 78 that the scheduler 78 may assign schedules for the processing elements to implement or execute the algorithms but that the scheduler 78 may need to assign the schedules to the processing elements (e.g., processors 70, 71, 72) by minimizing or limiting the number of data transfers via one or more buses (e.g., buses 87, 88 and 89) for example. As a practical matter, a value of

$$\frac{{T}_{p + b}}{{T}_{ap}}$$

greater than 1 may be utilized by the scheduler 78 to determine which algorithms may need to be implemented by the same processing element (e.g., processor 70). If the ratio

$$\frac{{T}_{p + b}}{{T}_{ap}}$$

is smaller than 1, the scheduler 78 may determine that mapping of the algorithms onto the processing elements (e.g., processors 70, 71, 72) is possible but may not be guaranteed. In this regard, the scheduler 78 may generate a suitable schedule that would enable a device (e.g., apparatus 50) to implement all algorithms of all radios within the corresponding time interval or deadline.

When the scheduler 78 determines that the value of η or η′ is less than 1, the scheduler 78 may map the combined radios (and the associated algorithms) onto the processing elements (e.g., processors 70, 71, 72) of apparatus 50. In other words, if the scheduler 78 does not determine that scheduleability is impossible, the scheduler 78 may map or assign the radios onto the processing elements (e.g., processors 70, 71, 72).

The mapping of the radios onto the processing elements may be performed by the scheduler 78 by utilizing equation (8) below.

$${f}_{r} ( t ) = ( \begin{matrix}{f}_{r}^{1} ( t ) \\ ⋮ \\ {f}_{r}^{n} ( t )\end{matrix} ) = ( \begin{matrix}{\sum }_{k = 0}^{( \frac{{T}_{lcm}}{{T}^{1}} - 1 ) {T}^{1} + {m}_{1}} {1}_{{A}_{k}^{1}} ( t ) \\ ⋮ \\ {\sum }_{k = 0}^{( \frac{{T}_{lcm}}{{T}^{1}} - 1 ) {T}^{n} + {m}_{n}} {1}_{{A}_{k}^{n}} ( t )\end{matrix} ) -> ( \begin{matrix}{PE}_{1} ( t ) \\ ⋮ \\ {PE}_{m} ( t )\end{matrix} ) = PE ( t ) , \qquad ( 8 )$$

It should be pointed out that equation (8) may be solved by using one or more scheduling policies (e.g., Earliest-Deadline-First (EDF), Rate Monotonic (RM), Deadline Monotonic (DM), etc.). As such, the scheduler 78 may determine whether the ability to schedule the combined radios onto the processing elements of the apparatus 50 is possible independently of the scheduling policy that may be utilized.

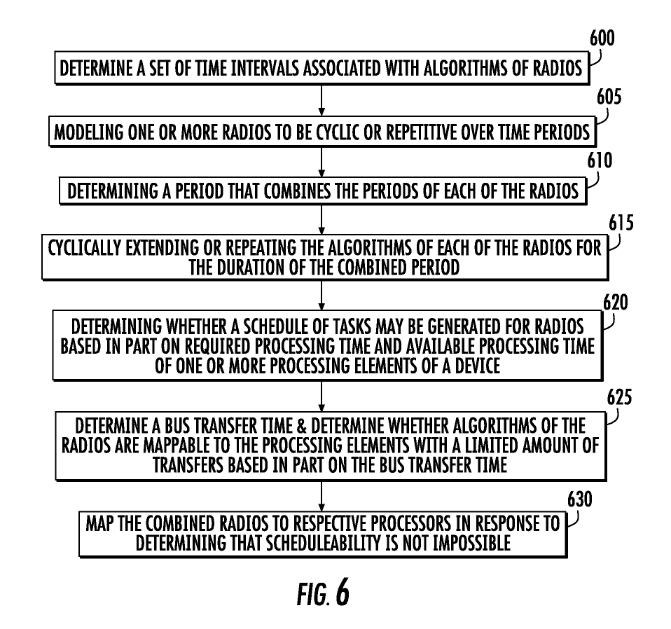

Referring now to FIG. 6, an exemplary embodiment of a flowchart for generating a cyclostationary extension for scheduling one or more periodic software tasks is provided. At operation 600, the scheduler 78 may determine a set of time intervals associated with a plurality of algorithms of corresponding radios. In this regard, the scheduler 78 may determine the set of time intervals based in part on utilizing equation (1). At operation 605, the scheduler 78 may model one or more radios to be cyclic or repetitive over a plurality of time periods. In an exemplary embodiment, the scheduler may model the radios by utilizing equations (2) and (3) in the manner described above. At operation 610, the scheduler 78 may determine a period that combines the periods of each of the radios. The determined period (also referred to herein as combined period) may be based in part on the least common multiple of the periods of each of the radios. In an exemplary embodiment, the scheduler 78 may determine the combined period in part based on the least common multiple of each of the periods associated with the radios.

At operation 615, the scheduler 78 may cyclically extend or repeat the algorithms of each of the radios for the duration (e.g., for the entire duration) of the combined period. At operation 620, the scheduler 78 may determine whether a schedule of assignments may be generated for radios (also referred to herein as combined radios) based in part on the required processing time associated with one or more processing elements and the available processing time of the processing elements (e.g., processors 70, 71 and 72) of a device (e.g., apparatus 50). At operation 625, the scheduler 78 may determine a bus transfer time and may determine whether algorithms of the radios are mappable to the processing elements (e.g., processors 70, 71 and 72) with a limited amount of transfers based in part on the bus transfer time. At operation 630, the scheduler 78 may map the combined radios to respective processing elements in response to determining that scheduleability of tasks or assignments to one or more of the processing elements (e.g., processors 70, 71, 72) is not impossible.

It should be pointed out that FIG. 6 is a flowchart of a system, method and computer program product according to exemplary embodiments of the invention. It will be understood that each block or step of the flowchart, and combinations of blocks in the flowchart, can be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above are stored by a memory device (e.g., memory device 76) and executed by a processor (e.g., processor 70, scheduler 78). As will be appreciated, any such computer program instructions may be loaded onto a computer or other programmable apparatus (e.g., hardware) to produce a machine, such that the instructions which execute on the computer or other programmable apparatus cause the functions specified in the flowchart blocks or steps to be implemented. In some embodiments, the computer program instructions are stored in a computer-readable memory that can direct a computer or other programmable apparatus to function in a particular manner, such that the instructions stored in the computer-readable memory produce an article of manufacture including instructions which implement the function specified in the flowchart blocks or steps. The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart blocks or steps.

Accordingly, blocks or steps of the flowchart support combinations of means for performing the specified functions and combinations of steps for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

In an exemplary embodiment, an apparatus for performing the method of FIG. 6 above may comprise a processor (e.g., the processor 70, scheduler 78) configured to perform some or each of the operations (600-630) described above. The processor may, for example, be configured to perform the operations (600-630) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (600-630) may comprise, for example, the processor 70 (e.g., as means for performing any of the operations described above), the scheduler 78 and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
determining a time period comprising a plurality of time periods associated with a plurality of radios or one or more other types of periodic software tasks, each of the radios or periodic software tasks comprise one or more algorithms that are executable during respective time intervals of the time period;
cyclically repeating each of the algorithms a number of times for the duration of the time period such that each of the algorithms are executable a plurality of times, according to the number, during the time period; and
determining whether each of the algorithms are assignable to one or more processors for execution during the respective time intervals based at least in part on a value.

2. The method of claim 1, further comprising determining a least common multiple associated with each of the time periods, the least common multiple is used in part to determine the time period.

3. The method of claim 1, further comprising, determining the value in part based on a determination of required processing time for each of the processors and available processing time of each of the processors.

4. The method of claim 1, further comprising:
determining at least one bus transfer time associated with a time for transferring data via at least one bus to one or more of the processors; and
determining whether algorithms are assignable to respective processors with a limited number of data transfers based in part on the bus transfer time.

5. The method of claim 4, further comprising:
determining that one or more assignments of algorithms to one or more processors is not guaranteed at least in part based on the bus transfer time.

6. The method of claim 2, further comprising determining whether the algorithms are assignable at least in part based on the least common multiple.

7. The method of claim 1, further comprising:
determining one or more types of the processors;
associating one or more groups of the algorithms with respective types of the processors;
determining a required processing time for each of the types of processors to execute the algorithms of respective groups; and
determining an available processing time for each of the types of processors to execute the algorithms of respective groups,
wherein determining whether each of the algorithms are assignable further comprises evaluating the required processing time and the available processing time.

8. An apparatus comprising:
at least one processor; and
at least one memory including computer program code, the at least one memory and the computer program code configured to, with the at least one processor, cause the apparatus to perform at least the following:
determine a time period comprising a plurality of time periods associated with a plurality of radios or one or more other types of periodic software tasks, each of the radios or periodic software tasks comprise one or more algorithms that are executable during respective time intervals of the time period;
cyclically repeat each of the algorithms a number of times for the duration of the time period such that each of the algorithms are executable a plurality of times, according to the number, during the time period; and
determine whether each of the algorithms are assignable to one or more processors for execution during the respective time intervals based at least in part on a value.

9. The apparatus of claim 8, wherein the at least one memory and the computer program code are further configured to, with the at least one processor, cause the apparatus to:
determine a least common multiple associated with each of the time periods, the least common multiple is used in part to determine the time period.

10. The apparatus of claim 8, wherein the at least one memory and the computer program code are further configured to, with the at least one processor, cause the apparatus to:
determine the value in part based on a determination of required processing time for each of the processors and available processing time of each of the processors.

11. The apparatus of claim 8, wherein the at least one memory and the computer program code are further configured to, with the at least one processor, cause the apparatus to:
determine at least one bus transfer time associated with a time for transferring data via at least one bus to one or more of the processors; and
determine whether algorithms are assignable to respective processors with a limited number of data transfers based in part on the bus transfer time.

12. The apparatus of claim 11, wherein the at least one memory and the computer program code are further configured to, with the at least one processor, cause the apparatus to:
determine that one or more assignments of algorithms to one or more processors is not guaranteed at least in part based on the bus transfer time.

13. The apparatus of claim 9, wherein the at least one memory and the computer program code are further configured to, with the at least one processor, cause the apparatus to:
determine whether the algorithms are assignable at least in part based on the least common multiple.

14. The apparatus of claim 8, wherein the at least one memory and the computer program code are further configured to, with the at least one processor, cause the apparatus to:
determine one or more types of the processors;
associate one or more groups of the algorithms with respective types of the processors;
determine a required processing time for each of the types of processors to execute the algorithms of respective groups; and
determine an available processing time for each of the types of processors to execute the algorithms of respective groups,
wherein the apparatus determines whether each of the algorithms are assignable by evaluating the required processing time and the available processing time.

15. A computer program product comprising at least one computer-readable storage medium having computer-executable program code instructions stored therein, the computer-executable program code instructions comprising:
program code instructions for determining a time period comprising a plurality of time periods associated with a plurality of radios or one or more other periodic software tasks, each of the radios or periodic software tasks comprise one or more algorithms that are executable during respective time intervals of the time period;
program code instructions for cyclically repeating each of the algorithms a number of times for the duration of the time period such that each of the algorithms are executable a plurality of times, according to the number, during the time period; and
program code instructions for determining whether each of the algorithms are assignable to one or more processors for execution during the respective time intervals based at least in part on a value.

16. The computer program product of claim 15, further comprising program code instructions for determining a least common multiple associated with each of the time periods, the least common multiple is used in part to determine the time period.

17. The computer program product of claim 15, further comprising program code instructions for determining the value in part based on a determination of required processing time for each of the processors and available processing time of each of the processors.

18. The computer program product of claim 15, further comprising:
program code instructions for determining at least one bus transfer time associated with a time for transferring data via at least one bus to one or more of the processors; and
program code instructions for determining whether algorithms are assignable to respective processors with a limited number of data transfers based in part on the bus transfer time.

19. The computer program product of claim 18, further comprising program code instructions for determining that one or more assignments of algorithms to one or more processors is not guaranteed at least in part based on the bus transfer time.

20. The computer program product of claim 16, further comprising program code instructions for determining whether the algorithms are assignable at least in part based on the least common multiple.

21. The computer program product of claim 15, wherein the value is determined at least in part on based on the time period.
